(19) United States
(12) Patent Application Publication
(10) Pub. No.: US 2025/0379903 A1
(43) Pub. Date: Dec. 11, 2025

(54) DATA TRANSMISSION METHOD AND APPARATUS, TRANSMISSION DEVICE, TERMINAL DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventor: Yong YANG, Shenzhen (CN)

(21) Appl. No.: 19/309,562

(22) Filed: Aug. 25, 2025

Related U.S. Application Data
(63) Continuation of application No. PCT/CN2024/093204, filed on May 14, 2024.

(30) Foreign Application Priority Data
Jul. 17, 2023 (CN) 202310874828.9

(51) Int. Cl. H04L 65/80; H04L 65/75

(52) U.S. Cl. CPC H04L 65/80; H04L 65/75

(57) ABSTRACT

A data transmission method includes determining, in response to a data retransmission request transmitted by a terminal device for service data, a data index corresponding to the data retransmission request. The service data is issued by a service device in response to a data pull request of the terminal device. The method further includes extracting, based on the data index and from a data cache queue, target retransmission data corresponding to the data retransmission request. The data cache queue caches the service data issued to the terminal device by the service device. The method also includes re-issuing the target retransmission data to the terminal device.

### CROSS-REFERENCE TO RELATED APPLICATIONS

This application is a continuation of International Application No. PCT/CN2024/093204, filed on May 14, 2024, which is based upon and claims priority to Chinese Patent Application No. 202310874828.9 filed on Jul. 17, 2023, the entire contents of both of which are incorporated herein by reference.

### FIELD OF THE TECHNOLOGY

This application relates to information transmission technologies, and in particular, to a data transmission method and apparatus, a transmission device, a terminal device, a computer-readable storage medium, and a computer program product.

### BACKGROUND OF THE DISCLOSURE

During data transmission, packet loss may occur for various reasons. In order to resolve the problem of packet loss, in the related art, after detecting packet loss, a terminal device will generate a data retransmission request and transmit the data retransmission request to a service device through a transmission device. After receiving the request, the service device will retransmit, according to the requirements of the request, data required by the terminal device. It can be seen that when packet loss occurs, the transmission link of the missing data during retransmission is relatively long, resulting in a relatively long delay for the terminal device to reobtain the missing data in the service data, consequently affecting the transmission efficiency of the service data.

### SUMMARY

In accordance with the disclosure, there is provided a data transmission method including determining, in response to a data retransmission request transmitted by a terminal device for service data, a data index corresponding to the data retransmission request. The service data is issued by a service device in response to a data pull request of the terminal device. The method further includes extracting, based on the data index and from a data cache queue, target retransmission data corresponding to the data retransmission request. The data cache queue caches the service data issued to the terminal device by the service device. The method also includes re-issuing the target retransmission data to the terminal device.

Also in accordance with the disclosure, there is provided a data transmission method including performing an integrity check on service data to obtain a check result. The service data is issued by a service device in response to a data pull request. The method further includes transmitting a data retransmission request to a transmission device in response to the check result indicating that the service data is incomplete, and receiving target retransmission data returned by the transmission device for the data retransmission request.

Also in accordance with the disclosure, there is provided a terminal device including a memory storing computer executable instructions, and a processor configured to execute the computer executable instructions to determine, in response to a data retransmission request transmitted by a terminal device for service data, a data index corresponding to the data retransmission request. The service data is issued by a service device in response to a data pull request of the terminal device. The processor is further configured to execute the computer executable instructions to extract, based on the data index and from a data cache queue, target retransmission data corresponding to the data retransmission request. The data cache queue caches the service data issued to the terminal device by the service device. The processor is also configured to execute the computer executable instructions to re-issue the target retransmission data to the terminal device.

### BRIEF DESCRIPTION OF THE DRAWINGS

FIG. 1 shows a processing process after packet loss occurs.

FIG. 2 is a schematic architectural diagram of a data transmission system according to an embodiment of this application.

FIG. 3 is a schematic structural diagram of a server in FIG. 2 according to an embodiment of this application.

FIG. 4 is a schematic structural diagram of a terminal in FIG. 2 according to an embodiment of this application.

FIG. 5 is a schematic flowchart of a data transmission method according to an embodiment of this application.

FIG. 6 is another schematic flowchart of a data transmission method according to an embodiment of this application.

FIG. 7 is another schematic flowchart of a data transmission method according to an embodiment of this application.

FIG. 8 is a schematic diagram of a system framework for short video pulling according to an embodiment of this application.

FIG. 9 is a schematic diagram showing a service processing process of video on demand according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following descriptions, related “some embodiments” describe a subset of all possible embodiments. However, the “some embodiments” may be the same subset or different subsets of all the possible embodiments, and may be combined with each other without conflict.

In the following descriptions, the included term “first/second” is merely intended to distinguish similar objects but does not indicate a specific order of an object. “First/second” is interchangeable in terms of a specific order or sequence if permitted, so that the embodiments of this application described herein can be implemented in a sequence in addition to the sequence shown or described herein.

In this embodiment of this application, the term “module” or “unit” refers to a part that has a predetermined function and works together with other related parts to achieve a predetermined goal, and may be implemented in whole or in part by using software, hardware (such as a processing circuit or a memory) or a combination thereof. Similarly, one processor (or a plurality of processors or memories) may be used to implement one or more modules or units. In addition, each module or unit may be a part of an integral module or unit that includes the function of the module or unit.

Unless otherwise defined, meanings of all technical and scientific terms used in this specification are the same as those usually understood by a person skilled in the art to which this application belongs. Terms used in this specification are merely intended to describe objectives of the embodiments of this application, but are not intended to limit this application.

Before the embodiments of this application are further described in detail, nouns and terms involved in the embodiments of this application are described. The nouns and terms provided in the embodiments of this application are applicable to the following explanations.
1) Packet loss refers to the phenomenon that a data packet fails to reach a target device correctly for various reasons and is lost during network transmission. Packet loss may be caused by network congestion, an excessively long data packet transmission distance, network signal interference, and the like.
2) Data index is index information configured for searching for data in a data cache queue. There is a mapping relationship between data indexes and data cached in the data cache queue. Through the mapping relationship, the corresponding cache data can be obtained from the data cache queue.
3) “In response to” is configured for indicating a condition or a status on which a to-be-performed operation depends. When the condition or the status is satisfied, one or more to-be-performed operations may be real-time or have a set delay. Unless otherwise specified, there is no chronological order between the plurality of to-be-performed operations.
4) Terminal device refers to a device on a user side of a data transmission link, a hardware device configured to directly provide applications, services, and the like to the user, or may alternatively be understood as a hardware device used by the user, such as a smartphone or a wearable device of the user.
5) Service device refers to a device that provides data services in a data transmission link. It is a device in the cloud that is configured to receive data uploaded by different users, process the data, and then provide the processed data to the users when the users need the processed data, such as a short video server or a game background server in the cloud.
6) Transmission device refers to a device between the service device and the terminal device in the data transmission link, and is configured to connect the terminal device and the service device to realize specific service functions. For example, when the terminal device visits a website, the transmission device is responsible for establishing a connection between the terminal device and a background service device of the website.
7) Hash Code is a method of creating a small digital “fingerprint” from any type of data. It converts inputted data (such as a character string and a number) into a fixed-length character string through a specific function (hash function). The character string is usually formed by numbers and/or letters.

During data transmission, packet loss may occur for various reasons. For example, in a video on demand scenario, when a short video is played on demand through a terminal device, network congestion may occur due to an excessively large quantity of users, busy service, and the like, resulting in packet loss. This will cause video frames of the short video to be lost, and the terminal device cannot play the short video normally.

In order to resolve the problem of packet loss, in the related art, after detecting packet loss, a terminal device will generate a data retransmission request and transmit the data retransmission request to a service device through a transmission device. After receiving the request, the service device will retransmit, according to the requirements of the request, data required by the terminal device.

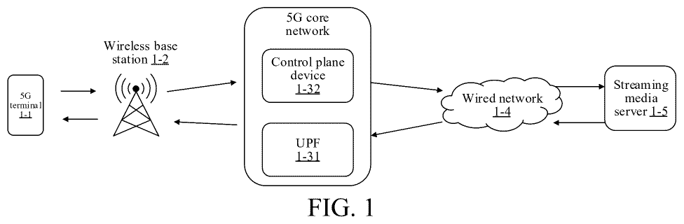

For example, FIG. 1 shows a processing process after packet loss occurs. When a video frame of a short video is lost, a user's 5th generation mobile communication technology (5G) terminal 1-1 (referred to as a terminal device) generates a data frame retransmission request and transmits the data frame retransmission request to a wireless base station 1-2 to reach a user plane function (UPF) 1-31 of the 5G core network (there is also a control plane device 1-32 in the 5G core network, and the UPF 1-31 may be referred to as a transmission device). The UPF of the 5G core network forwards the request to a wired network 1-4, and finally the request reaches a streaming media server 1-5 (referred to as a service device) that provides video on demand. The streaming media server 1-5 retransmits, according to requirements of the data frame retransmission request, the video frame requested by the 5G terminal 1-1, and the video frame is returned to the 5G terminal 1-1 along the original path.

It can be seen that when packet loss occurs in the terminal device, the transmitted data retransmission request needs to be transmitted to the service device through the wireless network and the wired network, and the service device is responsible for retransmitting data of the lost packet. This will cause a transmission link of the data of the lost packet, namely, the missing data, during retransmission to be relatively long, resulting in a relatively long delay for the terminal device to reobtain the missing data in the service data, that is, affecting the transmission efficiency of the service data.

Meanwhile, because the transmission link of the missing data during retransmission is relatively long, the uplink data retransmission request and the downlink retransmitted missing data are more prone to packet loss due to network uncertainty, that is, packet loss occurs again, further affecting the transmission efficiency of the service data. In addition, all data retransmission requests are processed by the service device, which will undoubtedly increase the load of the transmission network and the processing load of the service device.

Embodiments of this application provide a data transmission method and apparatus, a transmission device, a terminal device, a computer-readable storage medium, and a computer program product, which can improve the transmission efficiency of service data. The following describes exemplary applications of the transmission device and the terminal device provided in the embodiments of this application. The terminal device provided in the embodiments of this application may be implemented as various types of user terminals such as a notebook computer, a tablet computer, a desktop computer, a set-top box, and a mobile device, or may be implemented as a server. The transmission device provided in the embodiments of this application may be implemented as various types of user terminals such as a notebook computer, a tablet computer, a desktop computer, a set-top box, and a mobile device, or may be implemented as a server. An exemplary application in which the terminal device is implemented as a terminal, and the transmission device is implemented as a server will be described below.

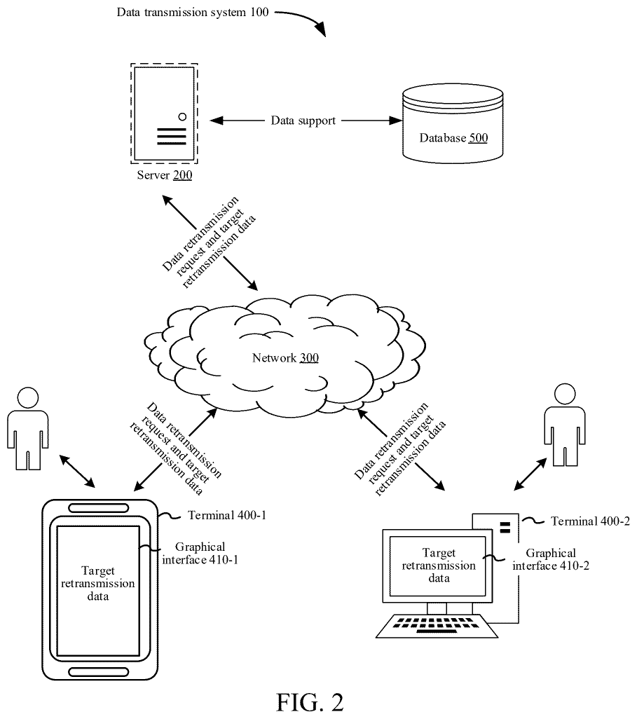

FIG. 2 is a schematic architectural diagram of a data transmission system according to an embodiment of this application. To support a data transmission application, in a data transmission system 100, terminals (where a terminal 400-1 and a terminal 400-2 are shown as an example) are connected to a server 200 through a network 300. The network 300 may be a wide area network, a local area network, or a combination thereof. In the data transmission system 100, a database 500 is further provided to provide data support to the server 200. The database 500 may be independent of the server 200, or may be provided in the server 200. FIG. 2 shows a case in which the database 500 is independent of the server 200.

The terminal 400-1 and the terminal 400-2 are respectively configured to perform integrity checks on service data to obtain check results; when the check results indicate that the service data is incomplete, transmit data retransmission requests to the server 200 through the network 300; receive target retransmission data returned by the server 200 in response to the data retransmission requests, and display the target retransmission data on a graphical interface 410-1 and a graphical interface 410-2.

The server 200 is configured to determine data indexes corresponding to the data retransmission requests in response to the data retransmission requests transmitted by the terminal 400-1 and the terminal 400-2 for the service data; extract, based on the data indexes and from a data cache queue, the target retransmission data corresponding to the data retransmission requests; and re-issue the target retransmission data to the terminal 400-1 and the terminal 400-2 through the network 300.

The embodiments of this application may be implemented by using the cloud technology. The cloud technology is a hosting technology that unifies a series of resources such as hardware, software, and networks in a wide area network or a local area network to implement computing, storage, processing, and sharing of data.

Cloud computing is a collective name of a network technology, an information technology, an integration technology, a management platform, an application technology, and the like based on an application of a cloud computing business mode, and may form a resource pool, which is used as required, and is flexible and convenient. The cloud computing technology becomes an important support. A system background service of a technical network requires a large amount of computing and storage resources, which need to be implemented through cloud computing.

For example, the server 200 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The terminal 400-1 and the terminal 400-2 may be smartphones, tablet computers, notebook computers, desktop computers, smart speakers, smartwatches, smart home appliances, in-vehicle terminals, or the like, but are not limited thereto. The terminal and the server may be directly or indirectly connected in a wired or wireless communication manner. This is not limited in the embodiments of this application.

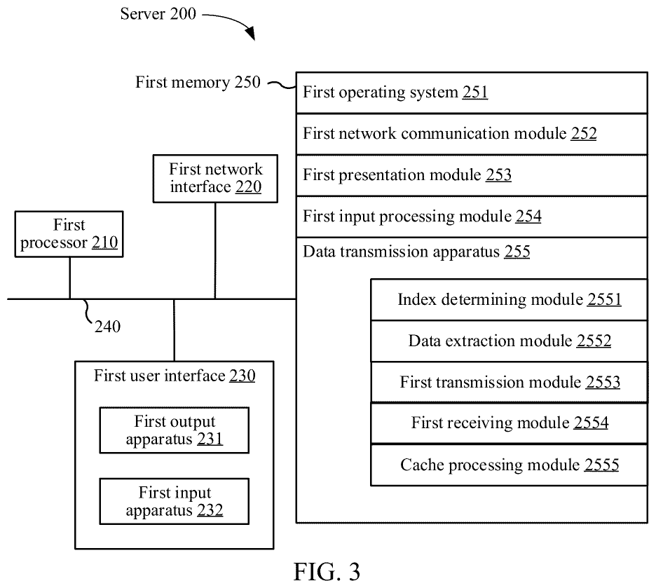

FIG. 3 is a schematic structural diagram of a server (an implementation of a transmission device) in FIG. 2 according to an embodiment of this application. The server 200 shown in FIG. 3 includes: at least one first processor 210, a first memory 250, and at least one first network interface 220. The server 200 includes a first user interface 230 in some embodiments. Components in the server 200 are coupled together by using a first bus system 240. The first bus system 240 is configured to implement connection and communication between the components. In addition to a data bus, the first bus system 240 further includes a power supply bus, a control bus, and a status signal bus. However, for ease of clear description, all types of buses are marked as the first bus system 240 in FIG. 3.

The first processor 210 may be an integrated circuit chip having a signal processing capability, for example, a general purpose processor, a digital signal processor (DSP), or another programmable logic device (PLD), discrete gate, transistor logical device, or discrete hardware component. The general purpose processor may be a microprocessor, any conventional processor, or the like.

The first user interface 230 includes one or more first output apparatuses 231 that can display media content, including one or more loudspeakers and/or one or more visual display screens. The first user interface 230 further includes one or more first input apparatuses 232, including user interface components that facilitate inputting of a user, such as a keyboard, a mouse, a microphone, a touch display screen, a camera, and other input button and control.

The first memory 250 may be a removable memory, a non-removable memory, or a combination thereof. Exemplary hardware devices include a solid-state memory, a hard disk drive, an optical disc driver, or the like. In some embodiments, the first memory 250 includes one or more storage devices that are physically away from the first processor 210.

The first memory 250 includes a volatile memory or a non-volatile memory, or may include both a volatile memory and a non-volatile memory. The non-volatile memory may be a read-only memory (ROM). The volatile memory may be a random access memory (RAM). The first memory 250 described in this embodiment of this application is to include any suitable type of memories.

In some embodiments, the first memory 250 may store data to support various operations. Examples of the data include a program, a module, and a data structure, or a subset or a superset thereof, which are described below by using examples.

A first operating system 251 includes a system program configured to process various basic system services and perform a hardware-related task, such as a framework layer, a core library layer, or a driver layer, and is configured to implement various basic services and process a hardware-based task.

A first network communication module 252 is configured to reach another computing device through one or more (wired or wireless) first network interfaces 220. Exemplary first network interfaces 220 include: Bluetooth, wireless compatible authentication (Wi-Fi), a universal serial bus (USB), and the like.

A first presentation module 253 is configured to present information by using one or more first output apparatuses 231 (for example, a display screen or a speaker) associated with the first user interface 230 (for example, a user interface configured to operate a peripheral device and display content and information).

A first input processing module 254 is configured to detect one or more user inputs or interactions from one of the one or more first input apparatuses 232 and translate the detected input or interaction.

In some embodiments, the data transmission apparatus provided in the embodiments of this application may be implemented by using software. FIG. 3 shows a data transmission apparatus 255 stored in the first memory 250. The apparatus may be software in a form such as a program and a plug-in, and includes the following software modules: an index determining module 2551, a data extraction module 2552, a first transmission module 2553, a first receiving module 2554, and a cache processing module 2555. These modules are logical modules, and may be randomly combined or further divided based on a function to be performed. The following describes functions of the modules.

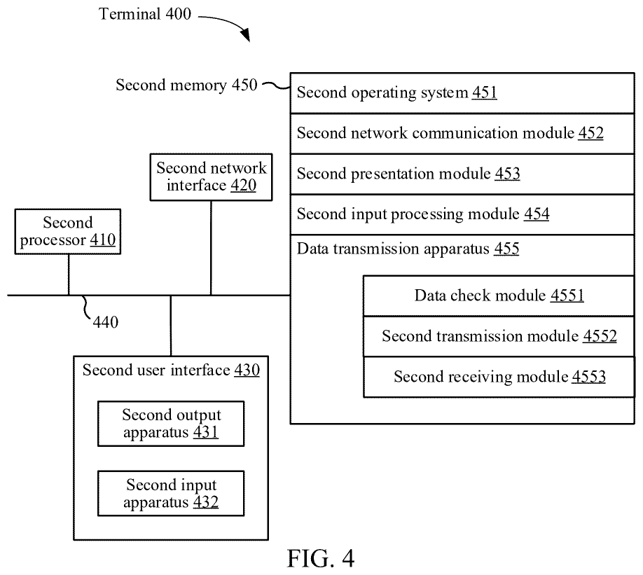

FIG. 4 is a schematic structural diagram of a terminal (an implementation of a terminal device) in FIG. 2 according to an embodiment of this application. The terminal 400 shown in FIG. 4 includes: at least one second processor 410, a second memory 450, at least one second network interface 420, and a second user interface 430. All the components in the terminal 400 are coupled together by a second bus system 440. The second bus system 440 is configured to implement connection and communication between the components. In addition to a data bus, the second bus system 440 further includes a power supply bus, a control bus, and a status signal bus. However, for ease of clear description, all types of buses are marked as the second bus system 440 in FIG. 4.

The second processor 410 may be an integrated circuit chip having a signal processing capability, for example, a general purpose processor, a DSP, or another PLD, discrete gate, transistor logical device, or discrete hardware component. The general purpose processor may be a microprocessor, any conventional processor, or the like.

The second user interface 430 includes one or more second output apparatuses 431 that can display media content, including one or more speakers and/or one or more visual display screens. The second user interface 430 further includes one or more second input apparatuses 432, including user interface components that facilitate inputting of a user, such as a keyboard, a mouse, a microphone, a touch display screen, a camera, and other input button and control.

The second memory 450 may be a removable memory, a non-removable memory, or a combination thereof. Exemplary hardware devices include a solid-state memory, a hard disk drive, an optical disc driver, or the like. In some embodiments, the second memory 450 includes one or more storage devices that are physically away from the second processor 410.

The second memory 450 includes a volatile memory or a non-volatile memory, or may include both a volatile memory and a non-volatile memory. The non-volatile memory may be a ROM. The volatile memory may be a RAM. The second memory 450 described in this embodiment of this application is to include any suitable type of memories.

In some embodiments, the second memory 450 can store data to support various operations. Examples of the data include a program, a module, and a data structure, or a subset or a superset thereof, which are described below by using examples.

A second operating system 451 includes a system program configured to process various basic system services and perform a hardware-related task, for example, a framework layer, a core library layer, and a driver layer, and is configured to implement various basic services and process a hardware-related task.

A second network communication module 452 is configured to reach another computing device through one or more (wired or wireless) second network interfaces 420. Exemplary second network interfaces 420 include: Bluetooth, wireless compatible authentication (WiFi), a universal serial bus (USB), and the like.

A second presentation module 453 is configured to present information by using one or more second output apparatuses 431 (for example, a display screen or a speaker) associated with the second user interface 430 (for example, a user interface configured to operate a peripheral device and display content and information).

A second input processing module 454 is configured to detect one or more user inputs or interactions from one of the one or more second input apparatuses 432 and translate the detected input or interaction.

In some embodiments, the data transmission apparatus provided in the embodiments of this application may be implemented by using software. FIG. 4 shows a data transmission apparatus 455 stored in the second memory 450. The apparatus may be software in a form such as a program and a plug-in, and includes the following software modules: a data check module 4551, a second transmission module 4552, and a second receiving module 4553. These modules are logical modules, and may be randomly combined or further divided based on a function to be performed. The following describes functions of the modules.

In some other embodiments, the data transmission apparatus 255 and the data transmission apparatus 455 provided in the embodiments of this application may be implemented by using hardware. For example, the data transmission apparatus 255 and the data transmission apparatus 455 provided in the embodiments of this application may be a processor in a form of a hardware decoding processor, programmed to perform the data transmission method on a transmission device side and the data transmission method on a terminal device side provided in the embodiments of this application. For example, the processor in the form of a hardware decoding processor may use one or more application-specific integrated circuits (ASIC), a DSP, a PLD, a complex programmable logic device (CPLD), a field-programmable gate array (FPGA), or other electronic components.

In some embodiments, the transmission device or the terminal device may implement the data transmission method provided in the embodiments of this application by running a computer program. For example, the computer program may be a native program or software module in the operating system, may be a native application (APP), that is, a program that needs to be installed in the operating system to run, such as a short video APP or an instant messaging APP, or may be an applet, that is, a program that only needs to be downloaded into a browser environment to run, and may alternatively be an applet that can be embedded into any APP. In summary, the computer program may be an application, a module, or a plug-in in any form.

Embodiments of this application is applicable to data transmission scenarios such as video on demand and live streaming. The data transmission method provided in the embodiments of this application is described below with reference to the exemplary application and implementation of the transmission device and the terminal device provided in the embodiments of this application.

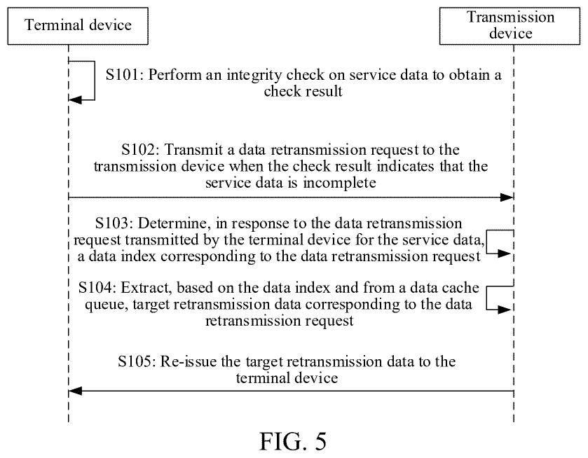

FIG. 5 is a schematic flowchart of a data transmission method according to an embodiment of this application, and operations shown in FIG. 5 are combined for description.
S101: A terminal device performs an integrity check on service data to obtain a check result.

This embodiment of this application is implemented in a scenario in which the terminal device pulls service data from a service device. More specifically, in this embodiment of this application, the service device has issued the service data to the terminal device in response to a data pull request transmitted by the terminal device. After obtaining the service data, the terminal device performs an integrity check on the service data to determine whether packet loss occurs during transmission of the service data, that is, to determine whether the obtained service data is incomplete. After the integrity check is completed, the terminal device can obtain the check result for the service data, so that the check result is configured for indicating whether the service data is incomplete.

The service data is issued by the service device in response to the data pull request of the terminal device. When transmitting the data pull request to the service device, the terminal device first transmits the data pull request to the transmission device, and then the transmission device forwards the data pull request to the service device. Correspondingly, when issuing the service data to the terminal device, the service device also transmits the service data to the transmission device, and the transmission device forwards the service data to the terminal device. In other words, in the embodiments of this application, the transmission device is configured to “connect” the terminal device and the service device. The transmission device may be a UPF of the 5G core network or an edge server.

The service data is associated with the service scenario of the specific application of the embodiments of this application. When the service scenario is a short video scenario, the service data is relevant data of a short video, for example, a video frame sequence of the short video; and when the service scenario is a live streaming scenario, the service data is relevant data of the live streaming, such as interactive messages of the live streaming (such as bullet comments and comments) and picture frames of the live streaming.

In some embodiments of this application, the service data includes: a video frame sequence; and in this case, S101 in FIG. 5, that is, a terminal device performing an integrity check on service data to obtain a check result, may be implemented through the following processing: completing the integrity check on the video frame sequence by performing a continuity detection on frame numbers of video frames in the video frame sequence, to obtain the check result.

In other words, after receiving the video frame sequence, the terminal device reads the frame numbers of the video frames in the video frame sequence and determines whether the frame numbers are continuous. If the frame numbers are continuous, it means that the video frame sequence is complete, so that a check result indicating that the video frame sequence is not incomplete can be obtained. If the frame numbers are discontinuous, for example, there are breaks, it means that the video frame sequence is incomplete and there are missing video frames, so that the terminal device can obtain a check result indicating that the video frame sequence is incomplete. In this way, the terminal device can complete the integrity check on the service data.
S102: The terminal device transmits a data retransmission request to a transmission device when the check result indicates that the service data is incomplete.

After completing the integrity check on the service data, the terminal device determines whether it is needed to re-pull the service data based on the check result. When the check result indicates that the service data is incomplete, that is, when packet loss occurs during transmission of the service data, the terminal device cannot normally display the service data to a user. In this case, the terminal device generates a data retransmission request and transmits the data retransmission request to the transmission device. The transmission device receives the data retransmission request transmitted by the terminal device. When the check result indicates that the service data is not incomplete, that is, when no packet loss occurs during the transmission of the service data, the terminal device does not transmit a data retransmission request to the transmission device, but normally displays the service data to the user.

The data retransmission request may include identification information of the terminal device, may also include identification information of the service device, and may further include identification information of to-be-retransmitted data (also referred to as “candidate data”). The to-be-retransmitted data may be the entire service data or the missing part of the service data that the terminal device has received, such as missing video frames or missing special effect pictures, which is not limited in the embodiments of this application.
S103: The transmission device determines, in response to a data retransmission request transmitted by a terminal device for service data, a data index corresponding to the data retransmission request.

After receiving the data retransmission request transmitted by the terminal device, the transmission device responds to the data retransmission request, that is, determines the corresponding data index, the data index being configured for searching for the data that needs to be re-issued to the terminal device.

The transmission device may determine the data index corresponding to the data retransmission request according to the identification information of the terminal device and the identification information of the service device. The transmission device may alternatively determine the data index corresponding to the data retransmission request according to the identification information of the to-be-retransmitted data, which is not limited in the embodiments of this application.

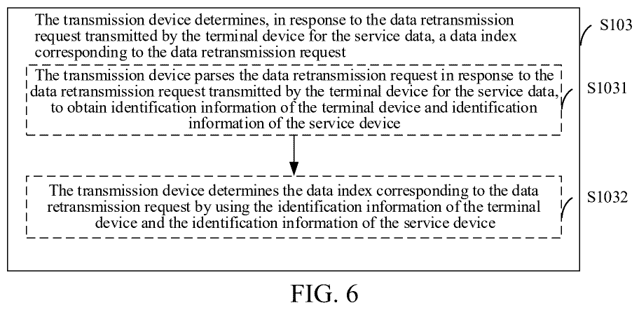

FIG. 6 is another schematic flowchart of a data transmission method according to an embodiment of this application. In some embodiments of this application, S103 in FIG. 5, that is, the transmission device determining, in response to a data retransmission request transmitted by a terminal device for service data, a data index corresponding to the data retransmission request, may be implemented through the following processing:
S1031: The transmission device parses the data retransmission request in response to the data retransmission request transmitted by the terminal device for the service data, to obtain identification information of the terminal device and identification information of the service device.

The transmission device parses the data retransmission request to respectively extract the identification information of the terminal device and the identification information of the service device. The identification information of the terminal device is configured for providing an identity and an address of the terminal device, while the identification information of the service device is configured for providing an identity and an address of the service device.

In this embodiment of this application, the identification information includes at least a routing address and a port number. That is, the identification information of the terminal device may include at least a routing address and a port number of the identification information, and the identification information of the service device may include at least a routing address and a port number of the service device. The routing address may be understood as an Internet Protocol (IP) address, and the port number identifies different applications on the device configured for communication.
S1032: The transmission device determines the data index corresponding to the data retransmission request by using the identification information of the terminal device and the identification information of the service device.

After obtaining the identification information of the terminal device and the identification information of the service device, the transmission device processes the obtained identification information to obtain the data index corresponding to the data retransmission request. In some embodiments, the transmission device may directly splice the identification information of the terminal device and the identification information of the service device, to obtain the data index of the data retransmission request. In some other embodiments, the transmission device may alternatively splice the identification information of the terminal device and the identification information of the service device to obtain a splicing result, perform hash coding on the splicing result to obtain a coding result, and use the coding result as a data index of the data retransmission request.

In some other embodiments of this application, S103 in FIG. 5, that is, the transmission device determining, in response to a data retransmission request transmitted by a terminal device for service data, a data index corresponding to the data retransmission request, may be implemented through the following processing: determining a corresponding data pull request for the data retransmission request, and using a request identifier of the data pull request as a data index of the data retransmission request.

That is, the transmission device first determines a data pull request returning the service data for which the data retransmission request is transmitted, that is, determines a data pull request to which the data retransmission request corresponds, and then uses a request identifier of the determined data pull request, such as a timestamp of the request or an identifier of the request, as a data index of the data retransmission request, to facilitate subsequent search for the service data corresponding to the data pull request.
S104: The transmission device extracts, based on the data index and from a data cache queue, target retransmission data corresponding to the data retransmission request.

After obtaining the data index, the transmission device searches the data cache queue for the corresponding data by using the data index, and extracts the found data from the data cache queue to obtain the target retransmission data that needs to be returned to the terminal device. In other words, in the embodiments of this application, after receiving the data retransmission request and generating the corresponding data index, the transmission device no longer forwards the data retransmission request to the service device, and the service device retransmits the data to the terminal device. Instead, the transmission device searches the data cache queue of the transmission device for the corresponding data by using the data index, to re-issue the corresponding data to the terminal device. In this way, the missing data in the service data can be re-issued without relying on the remote service device, thereby shortening the transmission link of the missing data in the service data during retransmission.

The data cache queue is configured for caching the service data issued to the terminal device by the service device. That is, when forwarding the service data issued by the service device to the terminal device, the transmission device also caches the service data, that is, “backs up” the service data by using the data cache queue. In this way, after receiving the data retransmission request from the terminal device, the transmission device no longer needs to forward the data retransmission request to the service device to trigger a data retransmission process, but the data retransmission is directly implemented by the transmission device.

The target retransmission data may be complete service data or missing data in the service data, that is, data in which packet loss has occurred. This is not limited in the embodiments of this application.
S105: The transmission device re-issues the target retransmission data to the terminal device.

After obtaining the target retransmission data, the transmission device transmits the target retransmission data to the terminal device through a network, and the terminal device receives the target retransmission data returned by the transmission device in response to the data retransmission request. In this way, the terminal device can obtain complete service data and provide the service data to the user.

Compared with the problem in the related art that the transmission link of the missing data during retransmission is relatively long, resulting in a relatively long delay for the terminal device to reobtain the missing data, finally causing relatively low transmission efficiency of the service data, in this embodiment of this application, after receiving a data retransmission request transmitted by a terminal device for service data, a transmission device determines a data index and obtains, by using the data index and from a data cache queue configured for caching the service data issued by the service device to the terminal device, data that needs to be re-issued to the terminal device, and does not need to obtain the to-be-re-issued data from the remote service device. In this way, the transmission link of missing data during retransmission can be shortened, so that the missing data in the service data can be obtained more quickly, thereby improving the transmission efficiency of the service data. Meanwhile, because the transmission link of the missing data during retransmission is shortened, the probability of packet loss for the data retransmission request and the missing data during retransmission can be reduced, thereby avoiding further impact on the transmission efficiency of the service data. In addition, transferring the data retransmission request to the transmission device side for implementation can decouple the service device from the data retransmission process, which can not only reduce the load of the transmission network (that is, reduce the quantity of requests transmitted to the service device), but also reduce the processing load of the service device.

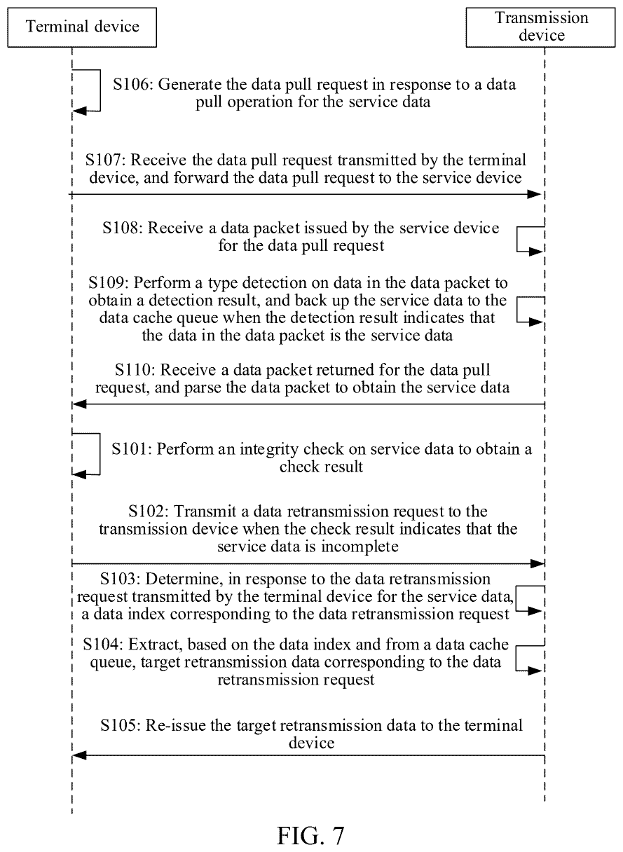

Based on FIG. 5, FIG. 7 is another schematic flowchart of a data transmission method according to an embodiment of this application. In some embodiments of this application, before S101 in FIG. 5, that is, before the terminal device performs an integrity check on service data to obtain a check result, the method may further include the following processing:
S106: The terminal device generates the data pull request in response to a data pull operation for the service data.

The terminal device performs detection on data pull operations of the user on the graphical interface. When the terminal device founds a data pull operation (such as refreshing a page of the service data or starting an application corresponding to the service data) of the user, the terminal device determines that the user needs to view the service data, and generates a packet for data pulling by using the identification information of the terminal device, and encapsulates the packet by using the identification information of the service device, to obtain a data pull request.
S107: The transmission device receives the data pull request transmitted by the terminal device, and forwards the data pull request to the service device.

After generating the data pull request, the terminal device transmits the data pull request to the transmission device through the network. After receiving the data pull request transmitted by the terminal device, the transmission device continues to forward the data pull request to the service device through the network. In other words, the transmission device is configured to forward the data pull request to the service device.
S108: The transmission device receives a data packet issued by the service device for the data pull request.

After receiving the data pull request, the service device (not shown in FIG. 7) obtains the corresponding service data and packages the service data to obtain a data packet that is more convenient for transmission, and then returns the data packet to the transmission device, to transmit the data packet to the terminal device through the transmission device.
S109: The transmission device performs a type detection on data in the data packet to obtain a detection result, and backs up the service data to the data cache queue when the detection result indicates that the data in the data packet is the service data.

After receiving the data packet, the transmission device performs a type detection on the data included in the data packet, that is, determines whether the data packet includes service data (such as a video frame sequence of a short video or interactive data of live streaming) or other types of data (for example, ordinary communication data). When the data included in the data packet is service data, the transmission device backs up the service data, that is, writes the service data into the data cache queue for storage. In this way, the service data can be retained on the transmission device side, thereby avoiding the need to reobtain the service data from the service device side during data retransmission.

In some embodiments of this application, that the transmission device performs a type detection on data in the data packet to obtain a detection result in S109 in FIG. 7 may be implemented through the following processing: parsing the data packet to obtain a data type identifier; and completing the type detection on the data in the data packet by reading the data type identifier, to obtain the detection result.

In other words, in the data packet, a data type identifier is usually set to indicate type information of the data included in the data packet. The data type identifier is written by the service device during generation of the data packet. After obtaining the data packet, the transmission device may parse the data packet to extract the data type identifier, and then read the data type identifier to clarify the type of the data in the data packet, that is, whether the data is service data or other ordinary types of data. In this way, the transmission device can complete the type detection on the data in the data packet, thereby obtaining a detection result for indicating whether the data in the data packet is the service data.

In some other embodiments of this application, S109 in FIG. 7, that is, that the transmission device performs a type detection on data in the data packet to obtain a detection result may alternatively be implemented through the following processing: completing the type detection on the data in the data packet by parsing a compression format of the data in the data packet, to obtain the detection result.

Different types of data may have different compression formats. For example, the compression format of short videos is Moving Picture Expert Group-4 (MPEG-4), the format of audio is Moving Picture Experts Group Audio Layer III (MP3), and web page data may be in a HyperText Markup Language (HTML) format. Therefore, the transmission device can determine the type of the data in the data packet according to the compression format of the data in the data packet, to obtain the detection result.

In this embodiment of this application, after obtaining the data packet and determining that the data in the data packet is the service data, the transmission device may directly write the service data into the data cache queue. However, in order to avoid excessive occupation of the storage space of the transmission device, the data cache queue usually has a certain capacity limit. In this case, the backing up the service data to the data cache queue when the detection result indicates that the data in the data packet is the service data in S109 in FIG. 7 may be implemented through the following processing: the transmission device performs a remaining capacity query on the data cache queue when the detection result indicates that the data in the data packet is the service data; the transmission device determines to-be-overwritten data (also referred to as “overwriting target data” or simply “target data”) from the data cache queue when a query result indicates that the data cache queue has insufficient remaining capacity; and the transmission device overwrites the to-be-overwritten data by using the service data, to complete backing up the service data to the data cache queue.

In other words, when backing up service data to the data cache queue, the transmission device first queries whether the service data can continue to be written into the data cache queue, that is, queries whether the data cache queue is full. When the data cache queue is full, the transmission device determines the to-be-overwritten data from data originally stored in the data cache queue, so that the to-be-overwritten data may be regarded as data that needs to be removed from the data cache queue. Subsequently, the transmission device directly overwrites the to-be-overwritten data in the data cache queue by using the service data. In this way, in a case that the data cache queue has insufficient remaining capacity, the service data can be backed up to the data cache queue.

The to-be-overwritten data may be any piece of data in the data cache queue, or may be the data that enters the data cache queue earliest, which is not limited in the embodiments of this application.

Certainly, when the query result indicates that the data cache queue has sufficient remaining capacity, the transmission device may directly write the service data into the data cache queue without removing other data.
S110: The terminal device receives a data packet returned by the transmission device for the data pull request, and parses the data packet to obtain the service data.

The transmission device forwards the data packet to the terminal device. After receiving the data packet returned by the transmission device, the terminal device parses the data packet to obtain the service data. So far, the terminal device has obtained the service data, so that the terminal device can provide the service data to the user.

In this embodiment of this application, the transmission device uses a data cache queue to make the service data be capable of being stored locally on the transmission device. In this way, when data retransmission is required, it is unnecessary to obtain the service data from the service device, which can shorten the transmission link during data retransmission.

The following describes an exemplary application of this embodiment of this application in an actual application scenario.

This embodiment of this application is applied to a video on demand scenario, that is, implemented in a scenario in which a user's 5G terminal (referred to as a terminal device) pulls video data (referred to as service data) of a short video (generally refers to a video with a duration less than a preset value, for example, 5 minutes) from a streaming media server (referred to as a service device) through a UPF (referred to as a transmission device) of a 5G core network.

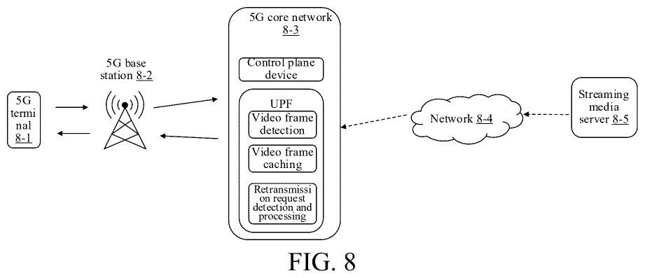

FIG. 8 is a schematic diagram of a system framework for short video pulling according to an embodiment of this application. Referring to FIG. 8, the system framework includes a 5G terminal 8-1, a 5G base station 8-2, a 5G core network 8-3, a network 8-4, and a streaming media server 8-5 in the cloud. The 5G core network 8-3 includes a control plane device and a UPF. The 5G UPF is configured to implement functions of video frame detection, video frame caching, and retransmission request detection and processing.

In other words, in the embodiments of this application, in the UPF of the 5G core network, three functions including video frame detection, video frame caching, and retransmission request detection and processing are added, to ensure that video frames can be retransmitted quickly when packet loss occurs during transmission of the video frames. These three functions are described below.

The video frame detection function is mainly responsible for detecting the downlink traffic transmitted by the streaming media server to the 5G terminal, that is, detecting whether the type of a downlink IP packet (referred to as a data packet) is video frames (referred to as service data).

The video frame caching function is mainly: when the type of the IP packet is video frames, for the video frames, additionally caching video frame data to the corresponding value domain internal memory according to 5G terminal IP address+port number (collectively referred to as identification information) and streaming media server IP address+port number as a key (referred to as a data index). When the amount of cached data exceeds a set threshold, the earliest data (referred to as to-be-overwritten data) is overwritten with new data, to ensure the validity of the cached data.

The retransmission request detection and processing function is mainly responsible for detecting a video frame retransmission request (referred to as a data retransmission request) transmitted by the 5G terminal in uplink. After the request is detected, 5G terminal IP address+port number and streaming media server IP address+port number are used as a key value to search the corresponding cache data area (referred to as a data cache queue), and then video frame data corresponding to the retransmission request (referred to as target retransmission data) is searched for from the cache data area and directly issued to the 5G terminal.

A detailed service processing process of video on demand is described below.

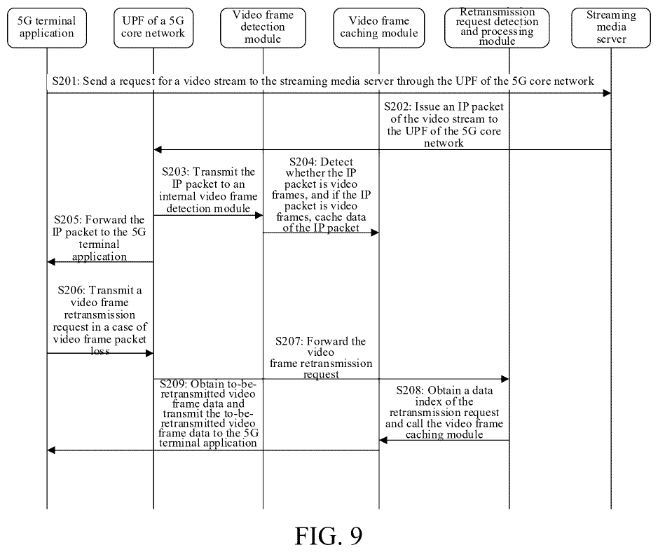

FIG. 9 is a schematic diagram showing a service processing process of video on demand according to an embodiment of this application. Referring to FIG. 9, the process includes the following operations:
S201: A 5G terminal application sends a request for a video stream to the streaming media server through the UPF of the 5G core network.
S202: The streaming media server issues an IP packet of the video stream to the UPF of the 5G core network.
S203: The UPF of the 5G core network transmits the IP packet to an internal video frame detection module.
S204: The video frame detection module detects whether the IP packet is video frames. If the IP packet is video frames, a video frame caching module caches data of the IP packet.
S205: The UPF of the 5G core network forwards the IP packet to the 5G terminal application.
S206: The 5G terminal application transmits a video frame retransmission request to the UPF of the 5G core network in a case of video frame packet loss.
S207: The UPF of the 5G core network forwards the video frame retransmission request to a retransmission request detection and processing module.
S208: The retransmission request detection and processing module obtains a data index of the retransmission request and calls the video frame caching module.
S209: The video frame caching module obtains to-be-retransmitted video frame data (also referred to as “candidate video frame data”) and transmits the to-be-retransmitted video frame data to the 5G terminal application.

In this embodiment of this application, the video frame caching function may also be deployed on an edge server for implementation, that is, the video frames are directed to the edge server for caching through the UPF of the 5G core network.

In this embodiment of this application, relevant data including user information such as a data pull request and service data are involved. When the embodiments of this application are applied to a specific product or technology, user permission or consent needs to be obtained, and the collection, use, and processing of the relevant data need to comply with relevant laws, regulations, and standards.

The following continues to describe an exemplary structure in which the data transmission apparatus 255 provided in the embodiments of this application is implemented as software modules. In some embodiments, as shown in FIG. 3, the software modules in the data transmission apparatus 255 stored in the first memory 250 may include:
an index determining module 2551, configured to determine, in response to a data retransmission request transmitted by a terminal device for service data, a data index corresponding to the data retransmission request, the service data being issued by a service device in response to a data pull request of the terminal device;
a data extraction module 2552, configured to extract, based on the data index and from a data cache queue, target retransmission data corresponding to the data retransmission request, the data cache queue being configured for caching the service data issued to the terminal device by the service device; and
a first transmission module 2553, configured to re-issue the target retransmission data to the terminal device.

In some embodiments of this application, the data transmission apparatus 255 further includes a first receiving module 2554 and a cache processing module 2555.

The first receiving module 2554 is configured to receive the data pull request transmitted by the terminal device; and receive a data packet issued by the service device for the data pull request.

The cache processing module 2555 is configured to perform a type detection on data in the data packet to obtain a detection result, and back up the service data to the data cache queue when the detection result indicates that the data in the data packet is the service data.

The first transmission module 2553 is further configured to forward the data pull request to the service device; and forward the data packet to the terminal device.

In some embodiments of this application, the cache processing module 2555 is further configured to parse the data packet to obtain a data type identifier; and complete the type detection on the data in the data packet by reading the data type identifier, to obtain the detection result; or complete the type detection on the data in the data packet by parsing a compression format of the data in the data packet, to obtain the detection result.

In some embodiments of this application, the index determining module 2551 is further configured to parse the data retransmission request in response to the data retransmission request transmitted by the terminal device for the service data, to obtain identification information of the terminal device and identification information of the service device; and determine the data index corresponding to the data retransmission request by using the identification information of the terminal device and the identification information of the service device, the identification information including at least a routing address and a port number.

In some embodiments of this application, the index determining module 2551 is further configured to splice the identification information of the terminal device and the identification information of the service device to obtain the data index corresponding to the data retransmission request; or splice the identification information of the terminal device and the identification information of the service device to obtain a splicing result; and perform hash coding on the splicing result to obtain a coding result, and determine the coding result as the data index corresponding to the data retransmission request.

In some embodiments of this application, the cache processing module 2555 is further configured to perform a remaining capacity query on the data cache queue when the detection result indicates that the data in the data packet is the service data; determine to-be-overwritten data from the data cache queue when a query result indicates that the data cache queue has insufficient remaining capacity; and overwrite the to-be-overwritten data by using the service data, to complete backing up the service data to the data cache queue.

The following continues to describe an exemplary structure in which the data transmission apparatus 455 provided in the embodiments of this application is implemented as software modules. In some embodiments, as shown in FIG. 4, the software modules in the data transmission apparatus 455 stored in the second memory 450 may include:
a data check module 4551, configured to perform an integrity check on service data to obtain a check result, the service data being issued by a service device in response to a data pull request;
a second transmission module 4552, configured to transmit a data retransmission request to a transmission device when the check result indicates that the service data is incomplete; and
a second receiving module 4553, configured to receive target retransmission data returned by the transmission device for the data retransmission request.

In some embodiments of this application, the second transmission module 4552 is further configured to generate the data pull request in response to a data pull operation for the service data; and transmit the data pull request to the transmission device, the transmission device being configured to forward the data pull request to the service device; and
the second receiving module 4553 is further configured to receive a data packet returned by the transmission device for the data pull request, and parse the data packet to obtain the service data.

In some embodiments of this application, the service data includes: a video frame sequence; and the data check module 4551 is further configured to complete the integrity check on the video frame sequence by performing a continuity detection on frame numbers of video frames in the video frame sequence, to obtain the check result.

An embodiment of this application provides a computer program product. The computer program product includes a computer program or computer executable instructions, the computer program or computer executable instructions being stored in a computer-readable storage medium. A first processor of a transmission device reads the computer executable instructions from the computer-readable storage medium, and executes the computer executable instructions, to cause the transmission device to perform the foregoing data transmission method on a transmission device side in the embodiments of this application; and a second processor of a terminal device reads the computer executable instructions from the computer-readable storage medium, and executes the computer executable instructions, to cause the terminal device to perform the foregoing data transmission method on a terminal device side in the embodiments of this application.

An embodiment of this application provides a computer-readable storage medium having computer executable instructions stored therein, and when the computer executable instructions are executed by a first processor, the first processor will be caused to perform the data transmission method on a transmission device side provided in the embodiments of this application, and when the computer executable instructions are executed by a second processor, the second processor will be caused to perform the data transmission method on a terminal device side provided in the embodiments of this application.

In some embodiments, the computer-readable storage medium may be a memory such as an FRAM, a ROM, a PROM, an EPROM, an EEPROM, a flash memory, a magnetic memory, a compact disc, or a CD-ROM; or may be various devices including one of or any combination of the foregoing memories.

In some embodiments, the computer executable instructions can be written in the form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

In an example, the computer executable instructions may, but do not necessarily, correspond to a file in a file system, and may be stored in a part of a file that saves another program or other data, for example, be stored in one or more scripts in a hypertext markup language (HTML) file, stored in a file that is specially used for a program in discussion, or stored in the plurality of collaborative files (for example, be stored in files of one or modules, subprograms, or code parts).

For example, the computer executable instructions may be deployed for execution on one transmission device or terminal device, execution on a plurality of transmission devices or a plurality of terminal devices located at one location, or execution on a plurality of transmission devices or a plurality of terminal devices that are distributed at a plurality of locations and that are interconnected through a communication network.

Based on the above, through the embodiments of this application, the transmission link of the missing data during retransmission can be shortened, so that the missing data in the service data can be obtained more quickly, thereby improving the transmission efficiency of the service data. Meanwhile, because the transmission link of the missing data during retransmission is shortened, the probability of packet loss for the data retransmission request and the missing data during retransmission can be reduced, thereby avoiding further impact on the transmission efficiency of the service data. In addition, transferring the data retransmission request to the transmission device side for implementation can decouple the service device from the data retransmission process, which can not only reduce the load of the transmission network, but also reduce the processing load of the service device.

The foregoing descriptions are merely embodiments of this application and are not intended to limit the protection scope of this application. Any modification, equivalent replacement, or improvement made without departing from the spirit and range of this application shall fall within the protection scope of this application.

What is claimed is:

1. A data transmission method comprising:
determining, in response to a data retransmission request transmitted by a terminal device for service data, a data index corresponding to the data retransmission request, the service data being issued by a service device in response to a data pull request of the terminal device;
extracting, based on the data index and from a data cache queue, target retransmission data corresponding to the data retransmission request, the data cache queue caching the service data issued to the terminal device by the service device; and
re-issuing the target retransmission data to the terminal device.

2. The method according to claim 1, further comprising, before determining the data index:
receiving the data pull request transmitted by the terminal device;
forwarding the data pull request to the service device;
receiving a data packet issued by the service device for the data pull request;
performing a type detection on data in the data packet to obtain a detection result, and in response to the detection result indicating that the data in the data packet is the service data, backing up the service data to the data cache queue; and
forwarding the data packet to the terminal device.

3. The method according to claim 2, wherein performing the type detection includes:
parsing the data packet to obtain a data type identifier, and performing the type detection on the data in the data packet by reading the data type identifier, to obtain the detection result; or performing the type detection on the data in the data packet by parsing a compression format of the data in the data packet, to obtain the detection result.

4. The method according to claim 2, wherein backing up the service data to the data cache queue includes:
performing a remaining capacity query on the data cache queue to obtain a query result;
determining target data to be overwritten from the data cache queue in response to the query result indicating that the data cache queue has insufficient remaining capacity; and
overwriting the target data using the service data.

5. The method according to claim 1, wherein determining the data index includes:
parsing the data retransmission request to obtain identification information of the terminal device and identification information of the service device, the identification information of the terminal device including at least a routing address and a port number of the terminal device, and the identification information of the service device including at least a routing address and a port number of the service device; and
determining the data index using the identification information of the terminal device and the identification information of the service device.

6. The method according to claim 5, wherein determining the data index using the identification information of the terminal device and the identification information of the service device includes:
splicing the identification information of the terminal device and the identification information of the service device to obtain the data index; or
splicing the identification information of the terminal device and the identification information of the service device to obtain a splicing result, and performing hash coding on the splicing result to obtain a coding result as the data index.

7. A non-transitory computer-readable storage medium storing computer executable instructions that, when executed by a processor, cause the processor to implement the data transmission method according to claim 1.

8. A data transmission method comprising:
performing an integrity check on service data to obtain a check result, the service data being issued by a service device in response to a data pull request;
transmitting a data retransmission request to a transmission device in response to the check result indicating that the service data is incomplete; and
receiving target retransmission data returned by the transmission device for the data retransmission request.

9. The method according to claim 8, further comprising, before performing the integrity check:
generating the data pull request in response to a data pull operation for the service data;
transmitting the data pull request to the transmission device for the transmission device to forward the data pull request to the service device;
receiving a data packet returned by the transmission device for the data pull request; and
parsing the data packet to obtain the service data.

10. The method according to claim 8, wherein:
the service data includes a video frame sequence; and
performing the integrity check includes:
performing a continuity detection on frame numbers of video frames in the video frame sequence, to obtain the check result.

11. A transmission device comprising:
a memory storing computer executable instructions; and
a processor configured to execute the computer executable instructions to implement the data transmission method according to claim 8.

12. The transmission device according to claim 11, wherein the processor is further configured to execute the computer executable instructions to, before performing the integrity check:
generate the data pull request in response to a data pull operation for the service data;
transmit the data pull request to the transmission device for the transmission device to forward the data pull request to the service device;
receive a data packet returned by the transmission device for the data pull request; and
parse the data packet to obtain the service data.

13. The transmission device according to claim 11, wherein:
the service data includes a video frame sequence; and
the processor is further configured to execute the computer executable instructions to, when performing the integrity check:
perform a continuity detection on frame numbers of video frames in the video frame sequence, to obtain the check result.

14. A non-transitory computer-readable storage medium storing computer executable instructions that, when executed by a processor, cause the processor to implement the data transmission method according to claim 8.

15. A terminal device comprising:
a memory storing computer executable instructions; and
a processor configured to execute the computer executable instructions to:
determine, in response to a data retransmission request transmitted by a terminal device for service data, a data index corresponding to the data retransmission request, the service data being issued by a service device in response to a data pull request of the terminal device;
extract, based on the data index and from a data cache queue, target retransmission data corresponding to the data retransmission request, the data cache queue caching the service data issued to the terminal device by the service device; and
re-issue the target retransmission data to the terminal device.

16. The terminal device according to claim 15, wherein the processor is further configured to execute the computer executable instructions to, before determining the data index:
receive the data pull request transmitted by the terminal device;
forward the data pull request to the service device;
receive a data packet issued by the service device for the data pull request;
perform a type detection on data in the data packet to obtain a detection result, and in response to the detection result indicating that the data in the data packet is the service data, backing up the service data to the data cache queue; and
forward the data packet to the terminal device.

17. The terminal device according to claim 16, wherein the processor is further configured to execute the computer executable instructions to, when performing the type detection:
parse the data packet to obtain a data type identifier, and performing the type detection on the data in the data packet by reading the data type identifier, to obtain the detection result; or
perform the type detection on the data in the data packet by parsing a compression format of the data in the data packet, to obtain the detection result.

18. The terminal device according to claim 16, wherein the processor is further configured to execute the computer executable instructions to, when backing up the service data to the data cache queue:
perform a remaining capacity query on the data cache queue to obtain a query result;
determine target data to be overwritten from the data cache queue in response to the query result indicating that the data cache queue has insufficient remaining capacity; and
overwrite the target data using the service data.

19. The terminal device according to claim 15, wherein the processor is further configured to execute the computer executable instructions to, when determining the data index:
parse the data retransmission request to obtain identification information of the terminal device and identification information of the service device, the identification information of the terminal device including at least a routing address and a port number of the terminal device, and the identification information of the service device including at least a routing address and a port number of the service device; and
determine the data index using the identification information of the terminal device and the identification information of the service device.

20. The terminal device according to claim 19, wherein the processor is further configured to execute the computer executable instructions to, when determining the data index using the identification information of the terminal device and the identification information of the service device:
splice the identification information of the terminal device and the identification information of the service device to obtain the data index; or
splice the identification information of the terminal device and the identification information of the service device to obtain a splicing result, and perform hash coding on the splicing result to obtain a coding result as the data index.
